(19) United States
(12) Patent Application Publication
(10) Pub. No.: US 2004/0204243 A1
(43) Pub. Date: Oct. 14, 2004

(54) Challenge-based electronic gaming systems and methods

(76) Inventor: Marcus Fortunato de Mello Costa, Las Vegas, NV (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/394,954

(22) Filed: Mar. 21, 2003

(51) Int. Cl. A63F 13/00

(52) U.S. Cl. 463/42

(57) ABSTRACT

A system and method for enabling challenge-based electronic gaming is described. In one preferred form, a system in accordance with the present invention may comprise a plurality of gaming terminals, or banks of gaming terminal, that are connected to a central server over a local area network (LAN), wide area network (WAN), or other communications network that may include, for example, the public service telephone network (PSTN) or Internet. The system is configured to enable a player at one terminal to initiate a wager against a player at another terminal and to, thereby, add an additional element of intrigue to a non-banked or CLASS 2 gaming environment.

### FIELD OF THE INVENTION

The present invention relates to electronic gaming systems and methods and, in particular, to systems and methods for enabling challenge-based electronic gaming. In one particularly innovative aspect, the present invention relates to systems and methods for enabling challenge-based electronic BINGO, KENO, and POKER gaming.

### BACKGROUND OF THE INVENTION

Over the last several years, substantial attention has been directed to the field of electronic gaming. For example, any visitor to Las Vegas will immediately notice the rows of video poker and electronic slot machines. These systems are typically “banked” systems that enable players to play against the house on skill and non-skill games, which utilize a random number generator and allow a lucky few players to walk away with substantial winnings. Such systems are typically found within the major gaming areas of the United States and the world, and the systems are typically referred to as “CLASS 3” gaming systems.

In other jurisdictions, for example, where state gaming authorities have not fully regulated gaming through state compacts with Native American Tribes, “banked” or CLASS 3 systems typically are not allowed. In these jurisdictions, typically referred to as CLASS 2 jurisdictions, players cannot wager against the house but, rather, can compete for a “pool” or “pot” of funds that is wagered by a group of players during a single game. Typical BINGO games are exemplary of these types of games. In such games, players typically pay a fixed fee, e.g., five dollars ($5.00), for a BINGO card, the fees for the cards are placed in a pool, and the winner of the game receives the pool of funds, or some portion of the pool. When operating games of this type, a house will typically take some percentage of the pool or pot as compensation for hosting the games. Similar CLASS 2 games are provided for PULL TABS, VIDEO REELS, KENO and POKER.

Although CLASS 2 games can be very popular, many more sophisticated gaming enthusiasts often find such games to be somewhat boring and lacking in competitive spirit. This is so, because the typical wager for a CLASS 2 game is often limited to several dollars, and the total pool or pot is often also somewhat limited. Hence, sophisticated gaming enthusiasts often lose interest in CLASS 2 gaming systems in a relatively short period of time.

It follows that a substantial need exists for new electronic gaming systems that can provide a more competitive and more interesting CLASS 2 environment or, alternatively, can provide for both CLASS 2 and CLASS 3 gaming within a single venue.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one particularly innovative aspect, the present invention is directed to challenge-based network wagering systems and methods. For example, in one preferred embodiment, a challenge-based electronic BINGO gaming system can allow players in a non-banked or CLASS 2 environment to challenge one or more other players to a wager on a given BINGO game. In this fashion, a challenge-based electronic BINGO gaming system in accordance with the present invention can add a level of competitiveness to a typical BINGO game and can create an environment, where even the most avid gaming enthusiast can stay interested in a non-banked environment.

In one presently preferred embodiment, a challenge-based electronic BINGO gaming system in accordance with the present invention may comprise a plurality of gaming terminals, or banks of gaming terminals, that are coupled to a central server facility via a local area network (LAN), wide area network (WAN), or other communications network. The gaming terminals preferably include a LCD panel with touch screen capability, a bill validator and/or card reader, a local processor, and software for enabling the gaming terminals to communicate with the central server. The gaming terminals and central server preferably utilize a WINDOWS XP operating system available from Microsoft Corporation and are configured to enable a player at one terminal to issue a challenge to one or more players at other terminals. A challenge may be defined as a direct wager on a given game, and the value of the wager may be controlled by the players. For example, a first player may issue a ten-dollar ($10.00) challenge to a second player, and the second player may either accept or decline the challenge. In a BINGO environment, the first of the two players to cover all of the numbers on his or her BINGO card wins the challenge and collects the wager (less a minor hosting fee charged by the house, if applicable).

In alternative embodiments, BINGO balls may be issued to the players in two or more sets, such that the players may have the opportunity to “double up” or increase a wager in mid-game. Such a configuration may allow players to increase a wager for the purpose of causing an opposing player to withdraw or “fold.” Thus, such a configuration can introduce the concept of “bluffing” into a BINGO or other electronic gaming environment.

In still other embodiments, a challenge-based network gaming system in accordance with the present invention may comprise a banked or CLASS 3 system that enables players participating in a challenge to collect all or a portion of a jackpot that is generated from an accumulation of wagers or fees over time. Such systems also may allow players to collect all or a portion of a progressive jackpot that is generated through a pool of gaming machines.

In still further embodiments, a challenge-based network gaming system in accordance with the present invention may comprise a banked, CLASS 3, or CLASS 2 system that enables players at designated game terminals to enter, at their discretion, one or more server generated network games. For example, players with valid credits on a terminal may opt to enter an electronic game that is executed over a local area network (LAN), wide area network (WAN), or other communications network. In this fashion, a system in accordance with the present invention can administer a game, such as POKER, and create a virtual gaming room, such as a POKER ROOM, where players can join, wager, fold, bluff, or cash out at any time.

Those skilled in the art will recognize that, based upon system design preferrences, it may be possible to execute challenge-based games and traditional games on an electronic gaming terminal in several different ways. For example, it is presently preferred that all challenge-based games enabled by a system in accordance with the present invention will be executed on a local or central server of the system, whereas traditional games may be executed on a local processor provided at the relevant terminal. In other embodiments, however, the local or central server may be tasked with all gaming activities.

In still another innovative aspect, a challenge-based network gaming system in accordance with the present invention may provide players with scheduled tournament games, where players may join at a given time with a fixed price and participate in, for example, a BINGO, KENO, POKER, or VIDEO REEL tournament. Such a system may award prizes or credits to a designated number of top participants at the end of the game or tournament.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is an illustration of a first embodiment of a challenge-based network wagering system in accordance with a preferred form of the present invention;

FIG. 2 is an illustration of a second embodiment of a challenge-based network wagering system in accordance with a preferred form of the present invention;

FIGS. 3(a)-3(d) illustrate screens that may be displayed to a user of a network wagering system in accordance with the present invention during a typical initiation sequence;

FIG. 4 provides an illustration of a typical data-tracking log that may be used to track activity of a user of a challenge-based network wagering system in accordance with preferred embodiments of the present invention;

FIG. 5 provides an illustration of a challenge activation screen that may be displayed by a challenge-based network wagering system in accordance with preferred forms of the present invention;

FIG. 6 provides an illustration of an exemplary BINGO game screen that may be displayed by a challenge-based network wagering system in accordance with preferred forms of the present invention;

FIG. 7 provides an illustration of an exemplary challenge initiation screen that may be displayed by a challenge-based network gaming system in accordance with preferred forms of the present invention;

FIGS. 8(a) and 8(b) provide illustrations of exemplary challenge acceptance screens that may be displayed by a challenge-based network gaming system in accordance with preferred forms of the present invention;

FIGS. 9(a)-9(d) provide illustrations of exemplary screens that may be displayed during an exemplary BINGO challenge executed on a challenge-based network gaming system in accordance with preferred forms of the present invention;

FIG. 10 provides an illustration of a typical screen that may displayed during a KENO challenge executed on a challenge-based network gaming system in accordance with preferred forms of the present invention; and

FIG. 11 provides an illustration of a typical screen that may be displayed during a POKER challenge executed on a challenge-based network gaming system in accordance with preferred forms of the present invention.

### DETAILED DESCRIPTION

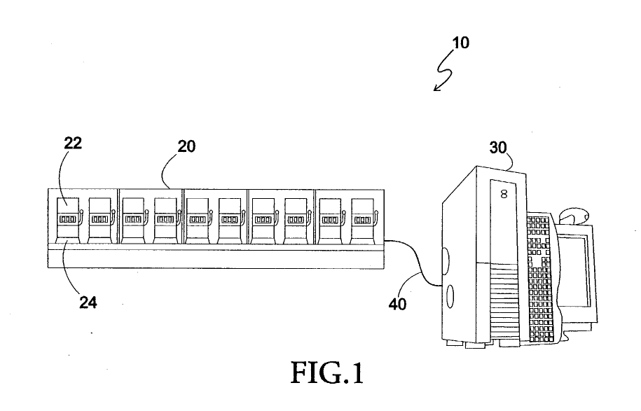

Referring now to the drawings, where like or similar elements are designated with identical reference numerals throughout the several views, and referring in particular to FIG. 1, a challenge-based network wagering system 10 is illustrated. The challenge-based network wagering system 10 comprises a plurality of gaming terminals 20 that are coupled to a central server 30 via a local area network (LAN) 40. The terminals 20 preferably include an LCD monitor 22 with touch screen capability, a bill validator (or card reader) 24, a local processor (not shown), and communications software for enabling communication with the central server 30 and other terminals 20. In a preferred form, the challenge-based network wagering system 10 utilizes a WINDOWS XP® operating system available from Microsoft Corp., but those skilled in the art will appreciate that numerous other operating systems including WINDOWS NT®, UNIX, and LINUX may be utilized within systems in accordance with the present invention.

In a presently preferred embodiment, the gaming terminals 20 may be housed in standard gaming cabinets and may be similar to terminals available from one of several major manufacturers including, for example, IGT-International Game Technology, Bally Gaming, WMS, and Aristocrat. The terminals 20 may be fitted within standard cabinets, large or small format cabinets, or non-standard cabinets including, but not limited to, slant tops, uprights, or bar top terminals. Preferably, twenty or more terminals 20 will be provided at each wagering site, unless prohibited by law.

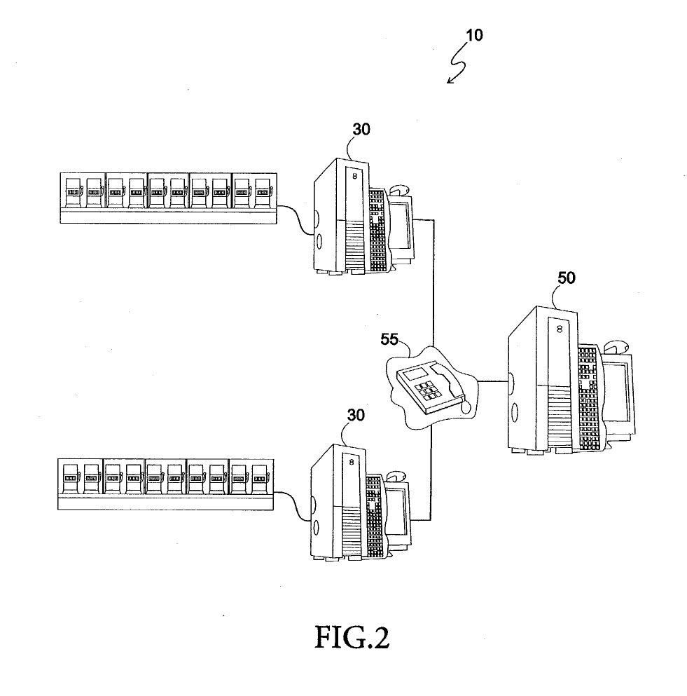

In an alternative embodiment, shown in FIG. 2, a plurality of challenge-based network gaming systems 10 may be coupled to a remote central server 50 over a wide area network (WAN) 55 or other communications network. The wide area network 55 may include the public service telephone network, satellite networks, radio frequency networks, and/or the Internet. When configured in this fashion, the linked network gaming systems 10 may take the form of a wide area progressive system, as is well known in the art.

Preferably, the game software executed on the challenge-based network gaming system 10 is divided into two platforms, a primary game platform and a challenge-based platform. Primary game platforms for games such as BINGO, KENO, VIDEO REELS, and POKER are well known in the art and, for that reason, are not discussed in detail herein. The process flow of a preferred challenge-based platform is described in detail below.

When not in use, the LCD monitors 22 of the terminals 20 will display a set of screens designed to attract users to the terminals 20. This mode is referred to herein as “attract mode.” Preferably, all terminals enter attract mode when a terminal is idle and unoccupied.

To initiate a game, a user must insert currency into the bill validator 24 or insert a credit, debit, or other gaming card into the card reader (not shown). Although the initiation sequence is described with reference to operation of the bill acceptor, those skilled in the art will appreciate that similar procedures can be used where a credit, debit, or other gaming card is used to initiate a game.

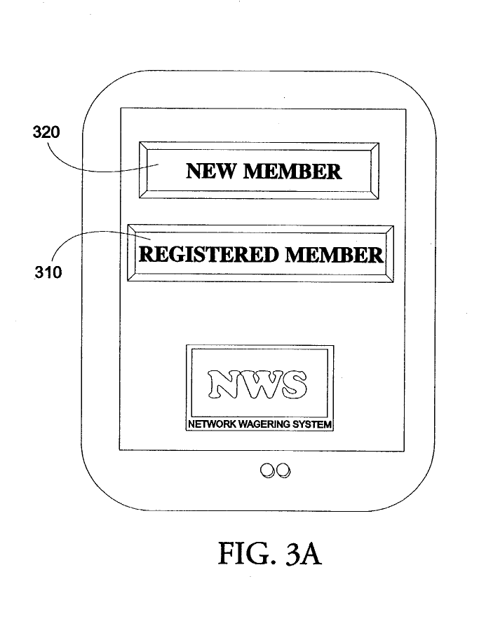

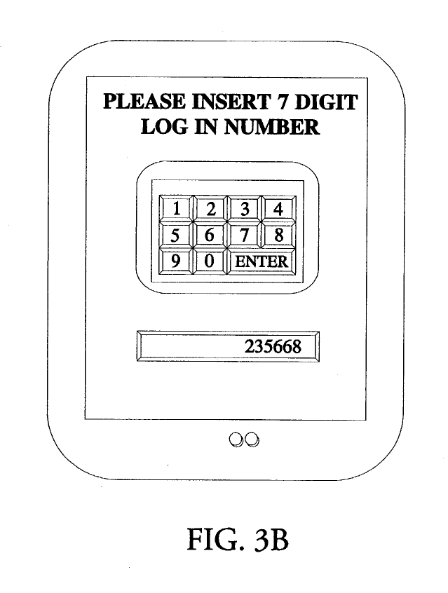

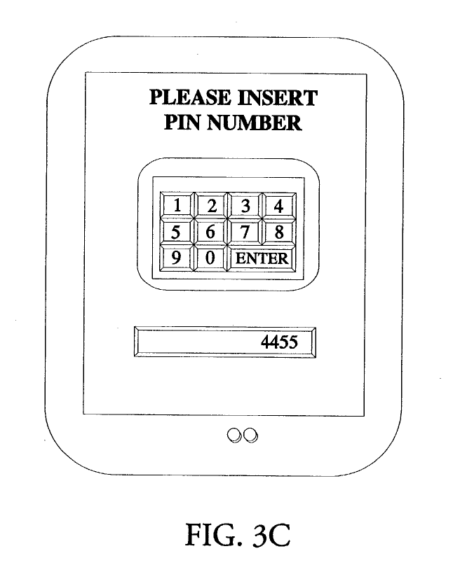

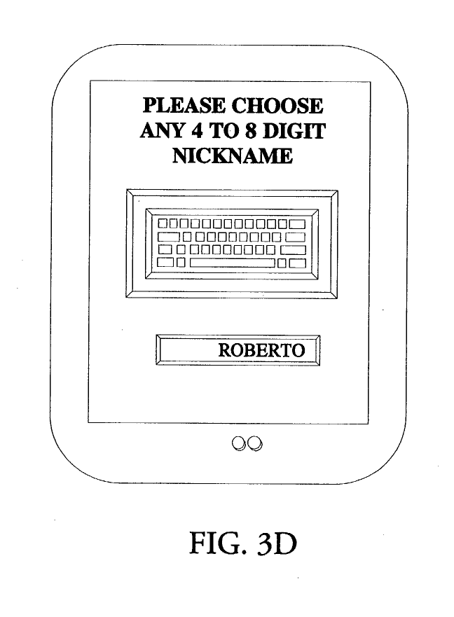

Turning now to FIGS. 3(a)-3(d), once a bill has been inserted into the bill acceptor 24 and a proper number of credits have been awarded to the player, based upon the value of the bill, the gaming software will interrupt the attract mode and initiate the game by displaying a player log-in screen (shown in FIG. 3(a)).

If a player is a “registered member,” the player need only touch the “registered member” icon 310 displayed on the terminal 20. The terminal 20 will then allow the player to enter a player ID number and a personal identification number (i.e., PIN). Assuming that the player ID number and PIN match, the game will be initiated. If the player is not a registered member, the player may touch the “new member” icon 320 displayed on the terminal 20. In response, the system 10 will guide the player through an enrollment process. To enroll, a player may select (or be assigned) a seven-digit number, which shall be established as the player's ID number within the system. Those skilled in the art will appreciate that the length of the player ID number can be varied depending upon system needs, the number of expected system users, etc. Once selected or assigned, the player ID number will be stored within a central database and will be used to track player activity, credits, and rewards.

Once the player ID number has been selected or assigned, the player will be asked to select a personal identification number (PIN) that will be associated with the player ID number and may be used to ensure that other players do not make use of the selected player ID number. Exemplary screens that may be displayed during the player ID number and PIN selection processes are shown in FIGS. 3(b) and 3(c).

Turning now to FIG. 3(d), once a player has enrolled by entering his or her player ID number and PIN into the system, the system will allow the player to select a player “nickname” using, for example, four to eight alpha-numeric digits. This feature enables players to identify other players on a gaming screen, while at all times preserving the actual identity of the players.

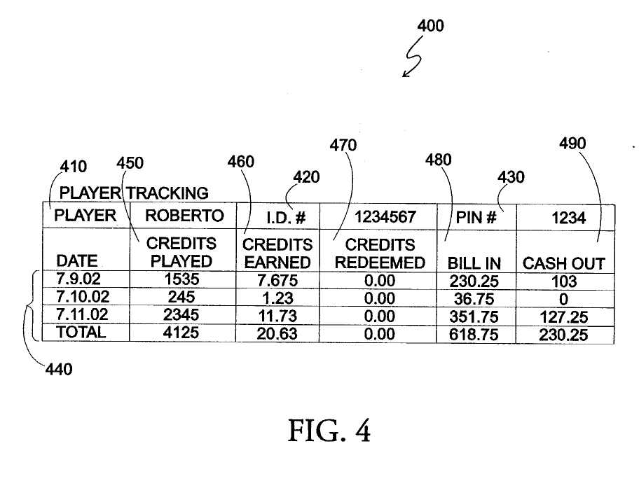

At typical data log record that may be used to track player activity within a database of the system is illustrated in FIG. 4. As shown, the player tracking record 400 includes several fields including a player field 410, which records the player's nickname, a player ID number field 420, and a PIN field 430. The data log record also contains several columns of data denoting the dates of any activity 440, credits played 450, credits earned 460, credits redeemed 470, cash paid into the system 480, and cash paid out of the system 490.

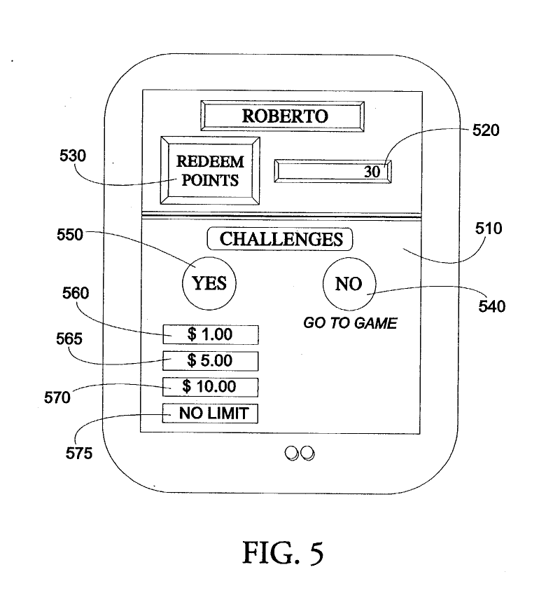

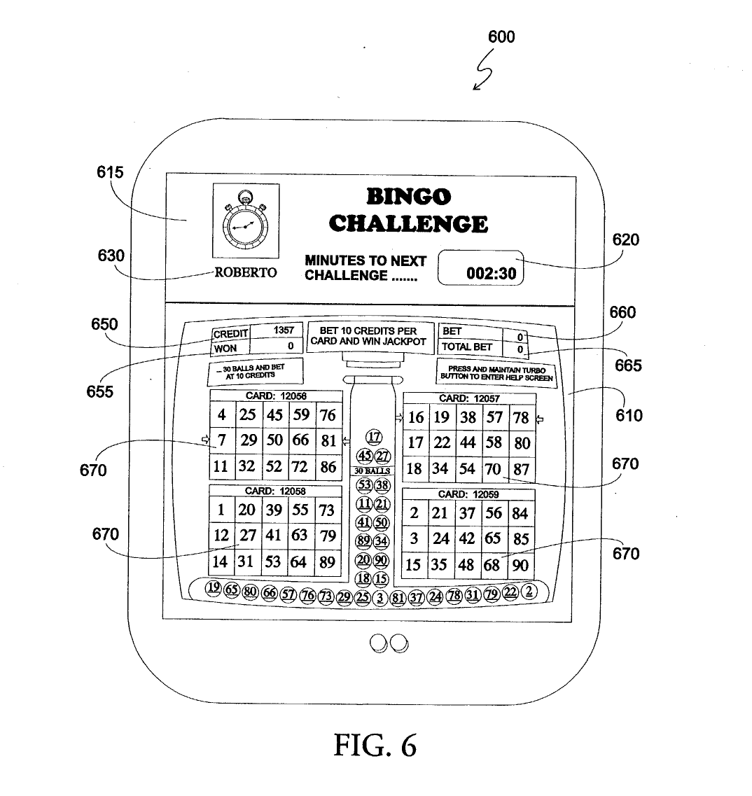

Turning now to FIG. 5, the next screen that will be displayed to a player preferably will be a challenge screen 510. At the top of the challenge screen 510, a player is preferably identified by his or her nickname. The player also will be presented with a points field 520 showing the player how may points he or she has accumulated within the system. The player may choose to redeem credits by touching the “redeem points” icon 530, and in such cases, the points will be added to the credit meter field (shown in FIG. 6) on the main game screen. The bottom portion of the screen may be used by the player to enable or disable the challenge mode of game operation for a given game or gaming session. The player may disable the challenge mode by touching the “no” icon 540 on the screen. If this action is taken, the player will be transported to the main gaming screen.

If the player chooses to enable the challenge mode by touching the “yes” icon 550, he or she will be prompted to establish a challenge wagering limit (i.e., an amount that can be wagered on any particular challenge). To establish a limit, the player may touch, for example, the $1.00 icon 560, the $5.00 icon 565, the $10.00 icon 570, or the “no limit” icon 575. In doing so, the player can select a prescribed limit for any challenge wagers. If a player's credits fall below the established limit, the system 10 will automatically transfer the player's limit to the previous amount shown on the scale down to the minimum of $1.00. In this fashion, a player is precluded from wagering more credits than he or she may have available within the system. Once a player's challenge limit has been established, the player will be transported to the main gaming screen (shown in FIG. 6).

Turning now to FIG. 6, the main game screen 600 preferably is divided into two sections 610 and 615. The first section 610 is dedicated to the primary game, BINGO in the illustrated example, and the second section 615 is dedicated to the challenge mode of operation. Preferably, the primary game will take the form of a typical stand-alone game, such as BINGO, and the challenge mode will be initiated on a periodic basis, for example, at three-minute intervals. In such an embodiment, the second section 615 of the main game display 600 provides an indication 620 of the time remaining before the next challenge round, and it may display the player's nickname in field 630, along with an animated stop watch.

As shown in FIG. 6, the main game display 600, a BINGO game as illustrated, includes a field 650 for indicating the number of credits available to a particular player, a field 655 for indicating player winnings, a field 660 for indicating a bet on a given BINGO card, and a field 665 for indicating a total bet on a given BINGO game. The illustrated screen 600 also includes displays of up to four BINGO cards 670, but those skilled in that art will appreciate that the number of displayed BINGO cards can readily be varied.

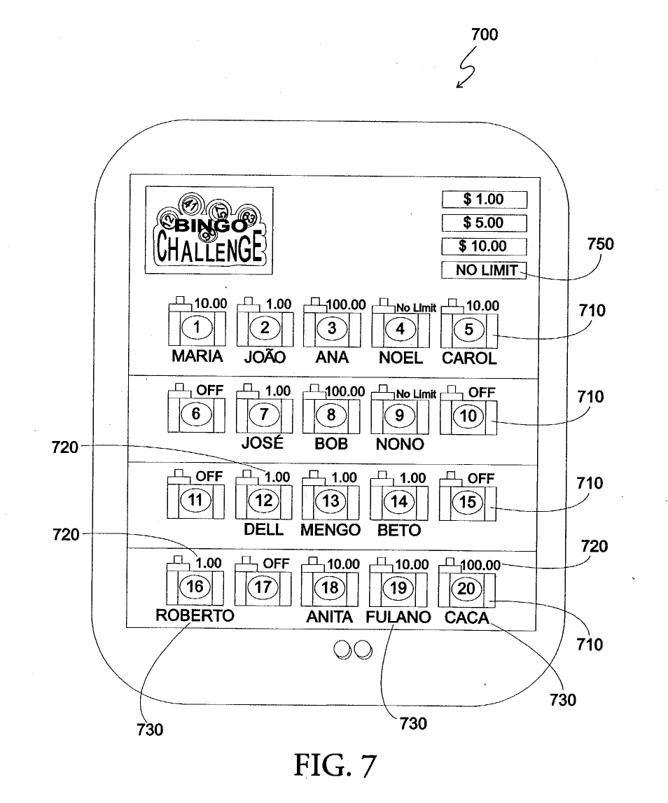

FIG. 7 provides an illustration of a challenge initiation screen 700. As shown, the challenge initiation screen 700 preferably comprises a plurality of symbols or icons 710 that correspond to and separately identify a plurality of electronic gaming terminals 20 located at a particular site. The screen 700 also preferably includes a first field 720 associated with each symbol 710 indicating a challenge-based wager limit that is acceptable to a user of an electronic gaming terminal 20 identified by the symbol 710. The screen 700 also preferably comprises a second field 730 associated with each symbol 710 indicating a nickname of the user of the electronic gaming terminal 20 identified by the symbol 710. For example, on the screen 700 the user of terminal number 16 is identified in the nickname field 730 as “Roberto,” and the limit displayed in the challenge limit field 720 associated with that terminal is $1.00.

Those skilled in the art will appreciate that, in alternative embodiments, for example, embodiments related to paramutual wagering, the screen 700 also may provide an indication of a wager that the user of a terminal either has made or intends to make. For example, the screen 700 could include another field (not shown) associated with each symbol 710 that indicates a horse that a user of the identified electronic gaming terminal picks as a winner of a future race. This would enable users of electronic gaming terminals 20 in accordance with the present invention to place wagers against each other with respect to the results of, for example, a particular horse race.

A player can initiate a challenge by touching a symbol or icon 710 on the screen 700 that corresponds to the user of another electronic gaming terminal 20. For example, if Roberto desires to initiate a challenge against the user of terminal number 1, Roberto would simply touch the symbol 710 associated with terminal number 1. Thereafter, Roberto would be prompted to enter the amount of the wager to be issued to Maria, the user of terminal number 1. In a preferred embodiment, the system will limit the value of each wager to an amount that does not exceed the value placed in the wager limit field 720 associated with a given terminal 20.

If a player wishes to place a wager with a “no limit” amount, the player may, for example, touch the no limit field 750 on the displayed wager scale 740. In a preferred embodiment, touching the no limit field 750 will cause a pop-up screen (not shown) to be displayed to the user. The pop-up screen may be used to enter a wager or challenge value selected by the user.

Preferably, the user or player will be allowed to wager only an amount equal to or less than the total credits he or she has available, as indicated on the primary game credit meter 650. The system 10 also preferably will charge a commission of, for example, 3% for all challenge wagers. Thus, if a player wagers $10.00 against another player, the total amount of the challenge will be equal to $19.40, and the commission on the wager would be equal to $0.60.

Once a challenge is accepted, the credit meters 650 of both players preferably will be reduced by the wagered amounts, and the winning challenger will be awarded the amount wagered in the form of credits denoted on the credit field 650 of the main game display 600.

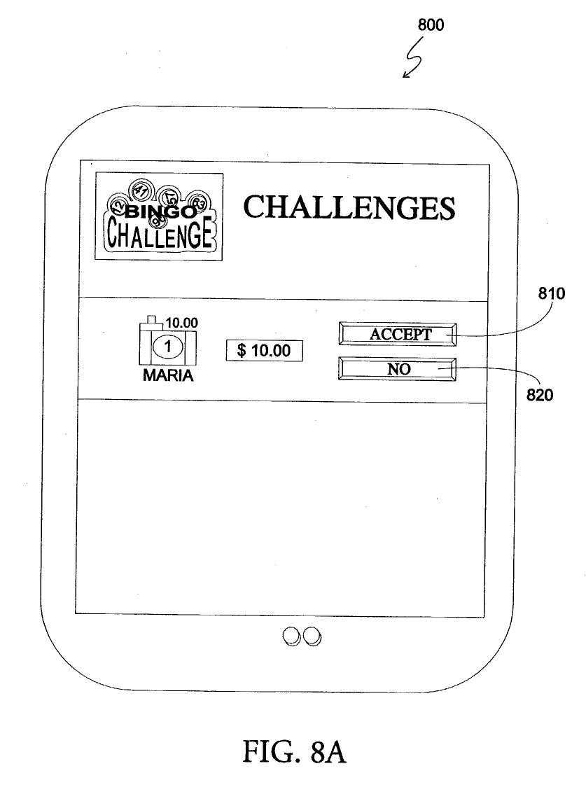

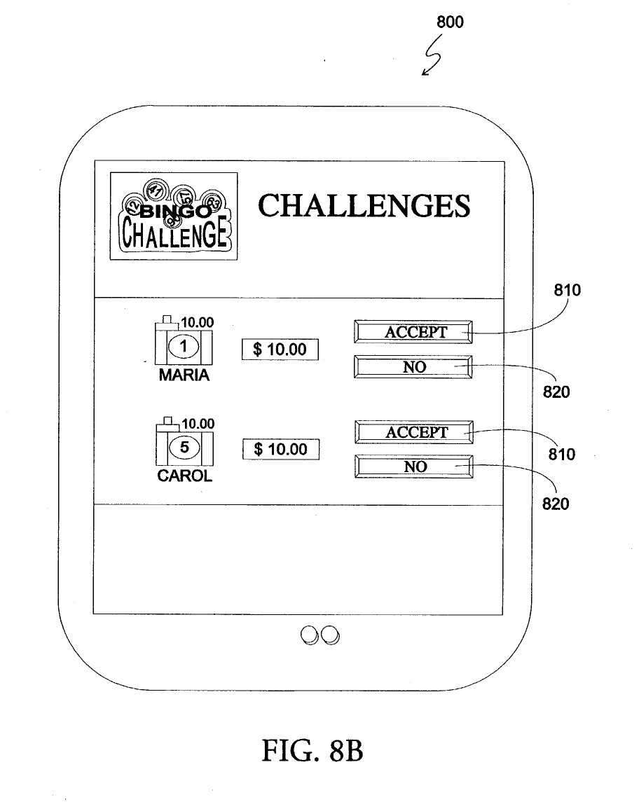

Turning now to FIGS. 8(a) and 8(b), once all wagers have been placed, the players will be prompted with a screen 800 showing all wagers that have been issued to the respective players. A player may accept a challenge or wager by touching an “accept” icon 810 on the screen 800, and a player may decline a challenge or wager by touching a “no” icon 820 on the screen 800. A player may accept multiple challenges or wagers, and each challenge will generate a specific wager between two players (i.e., between the users of two electronic gaming terminals 20). As is the case with initiating a challenge or wager, a player preferably must have sufficient credits to accept a challenge or wager. In the event that a player declines a challenge, the system 10 may be configured to present a “chicken” screen (not shown) to the player.

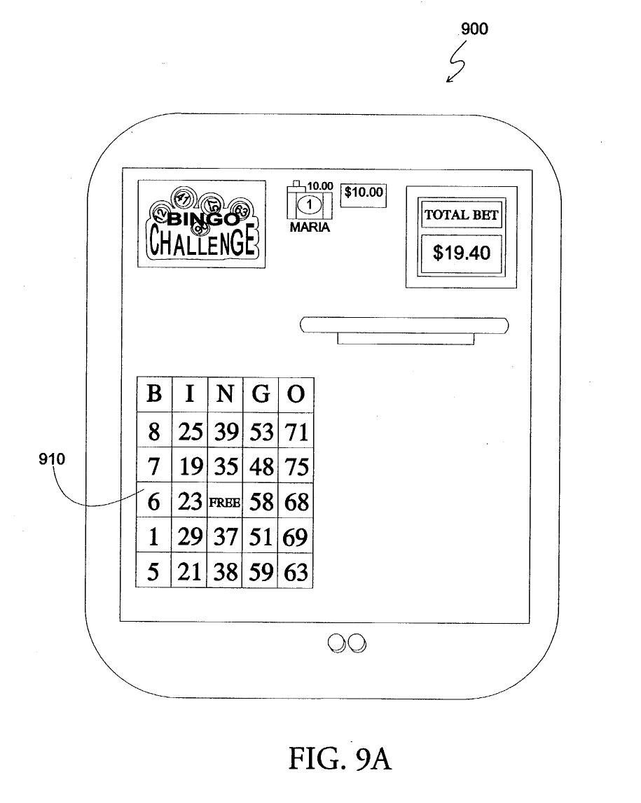

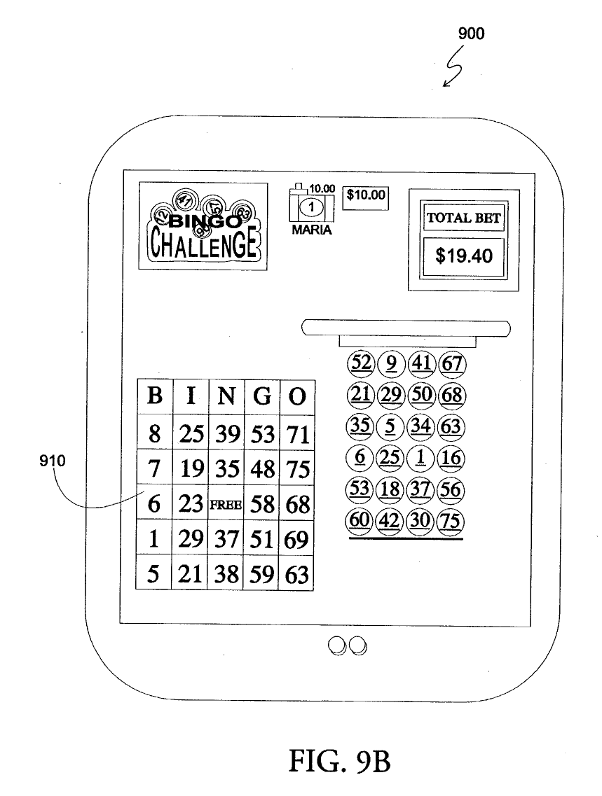

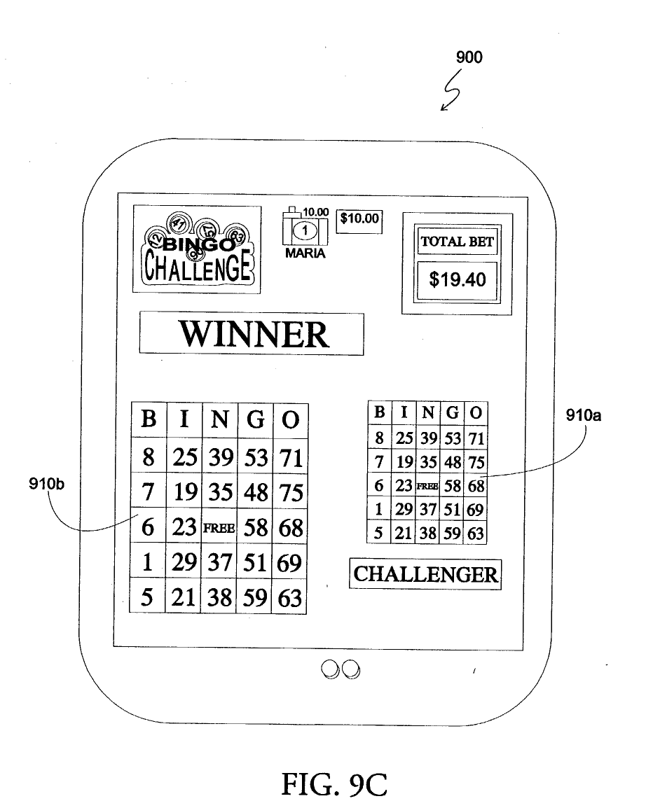

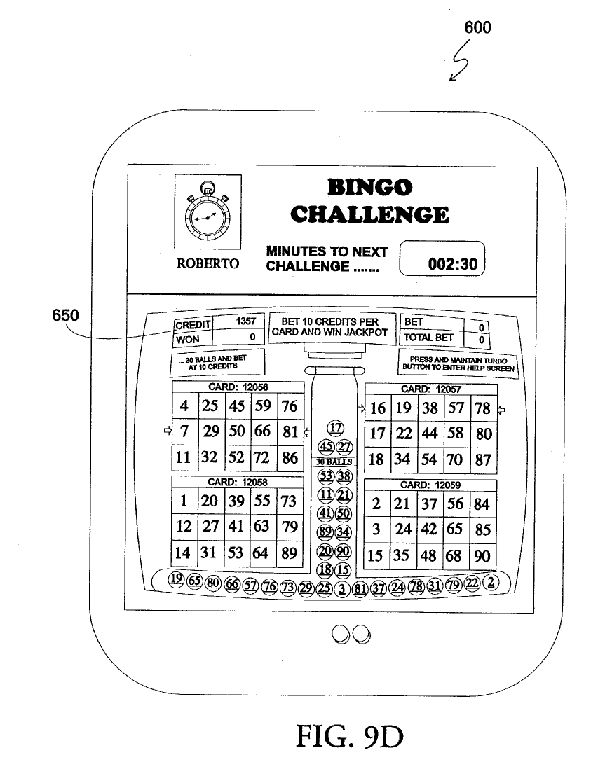

Turning now to FIGS. 9(a)-9(d), in one presently preferred embodiment, players may play a portion of a game, such as BINGO, and be given an opportunity increase their challenge wagers following completion of that game portion. For example, in a BINGO challenge, each player may be issued an electronic BINGO card 910 containing twenty-four numbers ranging, for example, from 1 to 75. The player may select a different electronic BINGO card 910 by touching the BINGO card 910 displayed on the screen 900. Once a game begins, the player will no longer be allowed to select a different card 910, and in a typical game players will not be allowed to view the cards 910 of other players until one of the players achieves a “cover all” and wins the challenge.

A challenge game may, however, be played in two or more draws. The first draw may consist of 24 numbers (e.g., 24 bingo balls), and the players may be prompted to increase their wagers or to “double up” their wagers following the initial draw. If a player is challenged to increase his or her wager, but declines to accept the challenge, the player may loose a portion of the original wager or the proposed increased wager. For example, if the challenge is to double a wager, and a player declines the challenge, 50% of the original wager may be deducted from the declining player's available credits and awarded (less a commission charge) to the challenging player's available credits. In this fashion, the concept of “bluffing” may be introduced to numerous electronic gaming environments such as BINGO and KENO.

As shown in FIG. 9(c), once a player has achieved a “cover all,” or other defined victory in a challenge, that player will be declared a “winner” and the opponents electronic game card 910(a) can be displayed adjacent the winner's game card 910(b). The credit meter 650 associated with the winning card 910(b) will be awarded all credits for the challenge.

In another preferred form, a player may be entitled to a challenge progressive “jackpot” if the player achieves a “coverall” with, for example, 40 balls or less drawn.

Once a challenge is concluded, all credits won or lost shall be deducted from, or added to, the primary credit meters 650 of the players, and the players will be returned to the primary game screens 600.

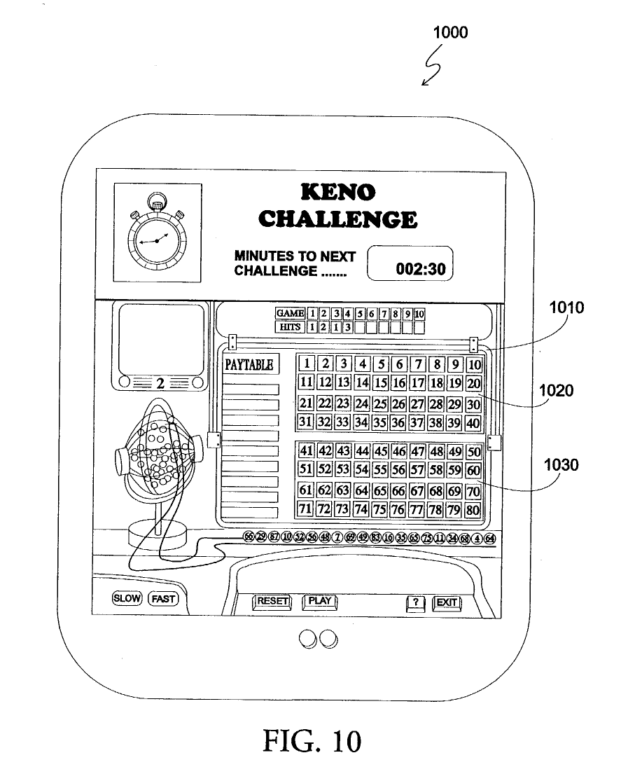

Turning now to FIG. 10, a typical main game screen 1000 for a KENO version of a challenge-based electronic gaming system 10 is displayed. The primary KENO game can be played using a standard KENO format with a progressive prize awarded to the maximum number of hits, as is well known in the art. Challenge mode may be implemented using, for example, the over/under game, where one player is assigned the upper half 1020 of the displayed card 1010, and another player is assigned the lower half 1030 of the displayed card 1010. In such a situation, one player selects the numbers 1-40, and the other player is assigned the numbers 41-80. Then, a full set of KENO balls (e.g., 20 balls) may be drawn. In an alternative embodiment, the players may be given an opportunity to increase their wagers following the drawing of, for example, ten KENO balls.

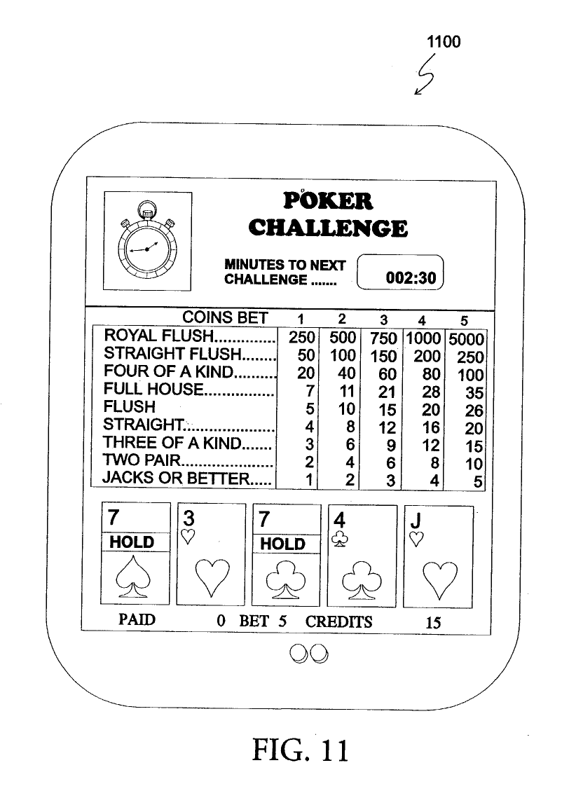

Turning now to FIG. 11, a typical main game screen 1100 for a typical electronic POKER game is displayed. The primary game in this embodiment is played on a standard POKER format with, for example, a progressive prize being awarded to a player achieving a “royal flush.” The challenge mode may be executed by processing a “heads-up” game of draw POKER and awarding the best hand the challenged amount. In the case of ties, the system 10 will draw additional hands until a winner is declared. If desired, the players may be given an opportunity to increase their challenge wagers following the dealing of an initial hand, and the winner of the game may be determined based upon the next or following hands. Each challenge preferably will be played with a single deck of 52 cards.

In conclusion, the present invention provides, among other things, a system and method for enabling challenge-based electronic wagering. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A challenge-based network gaming system comprising:
a plurality of electronic gaming terminals and a server linked together by a communications network;
said electronic gaming terminals being configured such that a user of a first terminal can initiate a challenge type wager to a user of a second terminal, and such that the user of the second terminal can accept the wager.

2. The challenge-based network gaming system of claim 1, wherein the electronic gaming terminals are further configured to enable the first and second users to enter challenge wager limits into their respective gaming terminals.

3. The challenge-based network gaming system of claim 1, wherein the electronic gaming terminals are configured to enable a user of each terminal to identify other users that are willing to enter into a challenge wager.

4. The challenge-based network gaming system of claim 3, wherein the electronic gaming terminals are configured to provide an indication of a limit that each user who is willing to enter a challenge wager is willing to wager and to enable each user that is willing to enter a challenge wager to enter such a wager with one or more other users that are also willing to enter a challenge wager.

5. The challenge-based network gaming system of claim 1 wherein said electronic gaming terminals comprise electronic BINGO gaming terminals, and said challenge type wager comprises a wager that the user of the first terminal will complete a first electronic BINGO card before the user of the second terminal completes a second electronic BINGO card.

6. The challenge-based network gaming system of claim 1 wherein said electronic gaming terminals comprise electronic KENO gaming terminals, and said challenge type wager comprises a wager that the user of the first terminal will achieve more hits on a first electronic KENO card than the user of the second terminal achieves on a second electronic KENO card.

7. The challenge-based network gaming system of claim 1, wherein said electronic gaming terminals comprise electronic POKER gaming terminals, and said challenge type wager comprises a wager that the user of the first terminal will draw a better hand of cards than will the user of the second terminal.

8. The challenge-based network gaming system of claim 1, wherein said electronic gaming terminals comprise electronic VIDEO REELS gaming terminals, and said challenge type wager comprises a wager that the user of the first terminal will achieve a number of pay line matches that exceeds a number of pay line matches achieved by the user of the second terminal.

9. The challenge-based network gaming system of claim 1, wherein said electronic gaming terminals comprise electronic POKER gaming terminals, and said electronic gaming terminals are configured to enable a user of a selected terminal to enter a virtual POKER game and wager, draw, bluff, fold, and cash out at the selected terminal.

10. A method for increasing a level of competitiveness in a CLASS 2 electronic gaming system, which comprises a plurality of electronic gaming terminals coupled to a central server by a communications network, the method comprising the steps of:
enabling the plurality of electronic gaming terminals to communicate with each other; and
enabling a user of a first electronic gaming terminal to issue a challenge type wager to a user of a second electronic gaming terminal.

11. The method of claim 10 further comprising the step of enabling the user of the first electronic gaming terminal to identify users of other electronic gaming terminals who may be interested in entering a challenge type wager.

12. The method of claim 11 further comprising the step of enabling selected users of the electronic gaming terminals to identify challenge-based wager limits of other users of the electronic gaming terminals.

13. An electronic gaming system comprising:
a first plurality of electronic gaming terminals coupled via a first communications network to a first server;
a second plurality of electronic gaming terminals coupled via a second communications network to a second server; and
a third server coupled to said first and second servers via a third communications network; wherein
the first and second plurality of electronic gaming terminals are configured such that a user of any one of said electronic gaming terminals can initiate a challenge type wager to a user of another one of said electronic gaming terminals.

14. The electronic gaming system of claim 13, wherein the first communications network comprises a first local area network, the second communications network comprises a second local area network, and the third communications network comprises a wide area network.

15. The electronic gaming system of claim 14, wherein the wide area network comprises a network selected from a group consisting of a public service telephone network, a satellite network, a radio frequency network, and the Internet.

16. The electronic gaming system of claim 15, wherein an instant messaging protocol may be used to notify one or more players using electronic gaming terminals of the gaming system when selected other players also are using electronic gaming terminals of the gaming system.

17. The electronic gaming system of claim 13 wherein the first and second pluralities of electronic gaming terminals comprise electronic BINGO gaming terminals.

18. The electronic gaming system of claim 13 wherein the first and second pluralities of electronic gaming terminals comprise electronic KENO gaming terminals.

19. The electronic gaming system of claim 13 wherein the first and second pluralities of electronic gaming terminals comprise electronic POKER gaming terminals.

20. The electronic gaming system of claim 13 wherein the first and second pluralities of electronic gaming terminals comprise electronic VIDEO REELS gaming terminals.

21. A method for improving a profitability measure of a selected CLASS 2 electronic gaming device, the method comprising the steps of:
enabling the selected CLASS 2 electronic gaming device to communicate with other CLASS 2 electronic gaming devices;
enabling a user of the selected CLASS 2 electronic gaming device to participate in both standard CLASS 2 gaming or challenge-based gaming; and
collecting as a service charge a percentage of all CLASS 2 and challenge-based wagers.

22. A method for executing challenge-based wagering within a network wagering system, the method comprising the steps of:
providing a plurality of electronic wagering terminals that are coupled together via a communications network;
configuring the electronic wagering terminals such that a user of a first terminal can identify wagers that users of other terminals are willing to make; and
configuring the electronic wagering terminals such that the user of the first terminal can issue challenge-based wagers to the users of selected other terminals, and such that the users of the selected other terminals can accept or decline the issued challenge-based wagers.

23. The method of claim 22 wherein the electronic wagering terminals are selected from a group consisting of electronic BINGO terminals, electronic KENO terminals, electronic POKER terminals, electronic VIDEO REELS terminals, and electronic paramutual wagering terminals.

24. The method of claim 23 wherein said paramutual wagering terminals comprise electronic wagering terminals that are used for wagering on either horse races or dog races.

25. An electronic wagering screen for use within a challenge-based electronic gaming system, the electronic wagering screen comprising:
a plurality of symbols corresponding to and separately identifying a plurality of electronic gaming terminals used within the challenge-based electronic gaming system; and
a first field associated with each symbol indicating a challenge-based wager limit that is acceptable to a user of an electronic gaming terminal identified by the symbol.

26. The electronic wagering screen of claim 25 further comprising a second field associated with each symbol indicating a nickname of the user of the electronic gaming terminal identified by the symbol.

27. A method for enabling bluffing within an electronic BINGO, VIDEO REELS, POKER, or KENO gaming environment, said method comprising the steps of:
enabling users of a plurality of electronic gaming terminals to issue challenge-based wagers to one another;
enabling the users of the plurality of electronic gaming terminals to play a first portion of an electronic game;
enabling the users of the plurality of electronic gaming terminals to issue increased challenge-based wagers to one another following completion of the first portion of the electronic game; and
enabling the users of the plurality of electronic gaming terminals to play a second portion of the electronic game.
